(19) United States
(12) Patent Application Publication
(10) Pub. No.: US 2024/0416781 A1
(43) Pub. Date: Dec. 19, 2024

(54) Mobile and Stationed Electrical Vehicles Charging System

(71) Applicant: Mutlaq Senhat Z. ALOTAIBI, Riyadh (SA)

(72) Inventor: Mutlaq Senhat Z. ALOTAIBI, Riyadh (SA)

(21) Appl. No.: 18/210,018

(22) Filed: Jun. 14, 2023

(51) Int. Cl. B60L 53/57; B60L 53/66

(52) U.S. Cl. CPC B60L 53/57; B60L 53/66; B60L 53/11

(57) ABSTRACT

A mobile and stationed charging system for electric cars designed to expand the charging infrastructure instead of the limited charging stations connected to public electricity networks, charging on the power of soundless electric generators to avoid noise, and operating on gasoline, diesel, natural gas, or hydrogen. To protect the environment, palladium is used in the catalytic converter to purify the exhaust gas, and a third level rapid charging device “high power charger” (HPC) is added. Fixed stations are integrated within the scope of traditional gas stations and may share with them the use of one of the fuels. Mostly they are independent. They can be installed and operated anywhere, either mobile stations on conventional or electric self-driving cars or with a driver with sufficient fuel tanks, with communication devices to meet charging requests anywhere. The charging system could be a solution for expanding the charging infrastructure.

### BACKGROUND OF THE INVENTION

The current invention falls under fixed and mobile charging services for charging electric cars of all kinds, an integrated system designed to expand the charging infrastructure, instead of limited charging connected to public electricity networks, charging on the power of soundless electric generators, fixed stations can be installed and operated anywhere, mobile stations on Vehicles equipped with communication devices to meet shipping requests.

Many sources confirm the weak infrastructure for charging electric cars, as the USA Ministry of Energy published news that about 80% of all car charging takes place in homes, ‘and first-level charging applications on electric voltage (120 volts) take approximately time 16-18 hours to charge a car with a capacity of 60 kilowatts per hour, and this is a very slow record time that suggests a severe shortage of electric charging stations in America and results in an increase in loads, network stress and power outages.

Given the importance of the issue from the environmental and economic aspects, especially if the number of electric cars is increased very dramatically in the coming years, it will face a big problem in charging stations because the public electricity networks are unable to withstand the severe pressure and the inability to meet the charging demand, and this is what the leaders of the automotive industry warned against. Electricity in Germany, Japan, and a British Parliamentary Committee, and we review their warnings below.

On Nov. 5, 2021, Oliver Zepze, CEO of the German company (BMW), warned that the capabilities of battery charging stations in Germany are not keeping pace with electric car sales; although electric cars are gaining acceptance, the expansion of charging networks continues slow.

He said that sales of electric cars in Germany are growing at a rate five times faster than charging capabilities, and in many European Union countries, there are no networks at all for charging stations, and that is why additional steps should not be taken toward a sharp reduction in carbon dioxide in Europe after 2030, except on the assumption that the charging infrastructure is already in place.

On 21 Dec. 2020, the president of Toyota Ikutoyoda warned, linking electric car charging stations to the electricity networks of major cities and said that electricity would run out in the summer if all cars were powered by electric power due to network stress and increased carbon emissions and that infrastructure will cost Japan Between 135-358 billion dollars.

On 3 Aug. 2021, the British Parliamentary Committee for Transport Affairs warned reports that electric charging of electric cars would constitute large loads on the networks that may lead to power outages, and they advised them to charge cars at intervals per day instead of fully charging once a day In order not to increase the loads on the networks and lead to the interruption of the electricity supply, due to the insufficient capacity of the generators.

### SUMMARY OF THE INVENTION

According to the references, companies involved in setting up electric vehicle charging stations face a challenge. They often need to be approved by local utility managers in order to connect to the net. Imagine what? It is not always an easy or quick process.

If you are in charge of a charging station project, you will know that the approximate calculation used is around $1,000 per kilowatt, which can result in investments in excess of $200,000 to $300,000, even before purchasing any charging equipment. This report is especially true if The site has weak network connections or is planned with connections that provide buildings only.

Another issue, sometimes more serious, is the time it takes local utility providers to build and operate new infrastructure to accommodate new network connections. Often, they will need to install new network lines or switches, leading to underground construction; the laying of the foundation stone requires approval by the city or local authorities, as well as lengthy phases of tendering and procurement, this can extend the overall construction time to a year or two.

Electric vehicle owners face two types of charging difficulties because drivers who live in apartments suffer from the fact that parking spaces are rarely equipped with charging infrastructure. The installation of this infrastructure can be prohibitively expensive for building managers. The second difficulty is the need for an expanded infrastructure for charging electric cars for long trips requiring multiple charging stops.

And when it comes to long trips, electric car owners worry about the driving range, which is the fear that the car will run out of electricity before a proper (and public) charging station is reached.

The current invention for charging stationed and mobile electric cars has a lower cost, its applications are easier, and its services are broader. It overcomes the challenges of charging public electricity networks, including the following:
1—There is no need for the approximate calculation of about $1,000 per kilowatt.
2—There is no need to install new grid lines or adapters.
3—There is no need for underground construction; there is no need to extend the construction time from one to two years.

Rather, there is only one thing to do: obtain approval and licenses from the authorities responsible for managing local facilities to adopt this distinguished service, which we believe will be welcome.

And sure enough, there is still very high demand for public chargers because electric cars don't go very far on a single charge-they need to be recharged regularly, so there's a huge market in the making-whichever way you look at it.

The electric vehicle charging stations market is expected to grow to more than $30 billion by 2023.

Expectations indicate that the European Commission's environmental strategy, known as the (Green Agreement) states that the European Union countries are obligated to expand the electric car charging stations grid. For its part, the German Automobile Industry Association believes that reducing gas emissions by 55% by 2030 requires an increase in the share of electric cars. Electric cars are among the total number of cars on the roads in the European Union.

### DETAILED DESCRIPTION

It is wrong and incorrect to claim that a diesel-powered car pollutes more than a gasoline-powered vehicle; on the contrary, a diesel engine is useful for reducing carbon dioxide emission and greenhouse effects compared to other fossil fuels because its efficiency is better and its cost is lower, in addition, it should be noted Diesel cars have a longer life, which must be taken into account when calculating pollution.

When we talk in kilograms of fuel, we get the following:
a) Gasoline: 0.74/2.28=3.08 kg of carbon dioxide/kg of gasoline (find the value 2).
B) Diesel: 0.85/2.67=3.14 kg/G 02 kg (we find the value: 3.16).
C) Liquefied gas: 0.55/1.66=3.02/G 02 kg liquefied petroleum gas (we find the value 3.02).

The cleanest fossil fuel is natural gas C H4, methane.

The difference in carbon dioxide when switching from diesel to methane is 2/2.75=3.16 . . . .

Or less by 0.87%, so it is certainly not natural gas that will save the climate.

The popularity of electric cars is increasing day by day, with 10 million electric cars roaming the streets of the world, and it is expected that the fleet of electric cars will reach 230 million cars by 2030, equivalent to 5% of cars globally, and its spread does not mean the end of the oil era, but it means more building Charging points on public electricity grid, which may not be able to keep up with the number of cars in the coming years, many governments encourage their citizens to switch to electric cars as they are environmentally friendly, do not make annoying sounds and are low in maintenance and consumption, but despite all these advantages are not the ideal solution, when The operation of electricity depends on electricity derived from burning fossil fuels, this does not add much to the efforts to protect the climate, and this falls within human activities that change global climate patterns, and threaten the lives of current and future generations with potentially severe economic and social consequences. (International Organization on Climate Change).

Since the alarm of global warming sounded on the planet, manufacturers have started to supply car exhaust with palladium metal—for its ability to catalyze the conversion of nearly 90% of harmful gases emitted from engines—especially carbon monoxide and nitrogen dioxide-into nitrogen and less carbon dioxide damage.

The second use of Palladium is hydrogen fuel cells, a popular technology for preserving and sustaining the environment.

According to the references, a 4-cylinder diesel generator of 45-60 kilowatts operates at its highest power, consuming 15.12 liters of diesel per hour×10 hours=151.2 liters of diesel×1.11=167.83 dollars, firing 2.6 kg×151.20=393.12 kg of carbon dioxide gas, and for comparison, we assume that we have 20 conventional 4-cylinder diesel cars that consume 694.40 liters in 10 hours at $770.78, and emit 1805.44 kg of carbon traveling a distance 10,000 ten thousand kilometers, compared to electric cars.

### Comparison Table Between the Consumption of Conventional Cars and Electric Cars in 2021

TABLE 1

| Engine | Consumption | Cost in | carbon | Distance |
|---|---|---|---|---|
| Comparison | amount | dollars | dioxide gas | in km |
| 1-20 diesel | 694,40 liters | $770,78 | 1805,44 kg | 20 × 500 = |
| coupe cars, 4 | | | | 10,000 km |
| cylinders | | | | |
| 2-20 electric | 151,20 liters | $176.8 | 393,12 kg | 20 × 500 = |
| cars with 130 | | | | 10,000 km |
| hp | | | | |
| Percentage | %97 | 72% | 78.22% | Equal |
| Reduction | | | | |

The following points show the analysis of Table (1):
1—It is known that electric cars are environmentally friendly and do not emit carbon emissions.
2—The comparison table shows us the amount of carbon emitted by the electric generator charging 20 electric vehicles within 10 hours, 393 kg, and the amount of carbon emitted by 20 4-cylinder diesel cars during 10 hours, 1805 kg; the difference ratio is 78.22% in favor of environmental protection. We will not be satisfied with this number.
3—The comparison was made before adopting the catalytic converter to purify exhaust, which contains metallic elements that absorb carbon emissions, such as Palladium, platinum, and rhodium; according to references, they absorb approximately 90% and represent 353.70 kg at a rate of 4 kg per hour instead of 180 kg per hour in traditional cars.
4—In light of the exacerbation of the problem of climate change, environmental protection may take precedence over saving oil and dollars, but in this invention, we were able to protect the environment and save oil and dollars together.
a) The quantities of diesel consumption are 79% less during 10 hours for the charging generator.
b) You are saving a dollar less by 72% within 10 hours for the charging generator.
c) How much will it be in 10 months or ten years?
d) This is the language of luminous numbers, which is an added value to any economist in the world.

### Global Energy Prices in Dollars 2021

1—A liter of gasoline costs $1.21, which gives a 6-cylinder car 12 km and emits 2.3 kg of carbon dioxide.

### Electric Vehicle Charging Prices

### Public Electricity Grid System 2021

1—Slow shipping cost per kilowatt 0.39, 0.79 average=0.59 dollars.
2—Express shipping cost per kilowatt is 6.99, 9.99 the average=8.49 dollars.
3—Slow charging, the cost of filling a car is 60 kilowatts×0.59=$35.40.

### Electric Vehicle Charging Prices: Invention System Energy Prices 2021

1—Fast charging cost of kilowatt-hours=0.28 dollars.
2—Fast charging for a vehicle of 60-kilowatt hours, 60×0.28=16.80 dollars.
3—The charge of the invention is less=35.40-16.80=$18.60 at a rate of 100%.

### Explain the Reduction Mechanism

1—The electric generator, according to what was mentioned in the references, if it is run at its highest capacity, consumes 15.12 liters of diesel per hour×10 hours per day=151.2×1.11=$167.80, 393.12 kg of carbon dioxide.
2—The invention designed a DC 480V fast charging system that charges the vehicle 60 kilowatts for 30 minutes.
3—Within 10 hours, it can complete 20 electric vehicles that absorb 1200 kilowatts of electricity from generators.
4—Diesel 151.20 liters=167.80×2=$335.66 Diesel, charger and operating costs=$335.66×100=1200=$0.28.
5—Fast car charging 60 kWh=60×0.28=$16.80.
6—The charge of the invention is less=35.40−16.80=$18.60 with 100% VAT.

### The Electric Car Charging Prices in Saudi Arabia 2021 Invention System.

1—Public stations, $0.17. Equivalent to 0.64 Halalas.=38.40 riyals for a car full of 60 kilowatts.
2—House charge, it takes 8-24 hours/0.65 Halalas.=39 riyals for filling a car of 60 kilowatts.

### The Electric Car Charging Prices in Saudi Arabia 2021 Invention System.

1—Fast charging, the cost of one kilowatt/hour=0.24 Halalas.
2—Fast charging of a 60-kilowatt-hour car=14.40 riyals.
3—The charge of the invention is less: 39−14.40=24.75 riyals, at a rate of 120%.

### Explain the Reduction Mechanism

1—The cost of a liter of diesel in Saudi Arabia will be 0.63 Halalas in 2022.
2—The electric generator consumes 15.12 liters of diesel per hour×10 hours per day=151.2 liters×0.63=95 riyals.
3—The fast charging device takes 30 minutes to fill a car with a 60 kilowatts/hour capacity. It charges within 10 hours 20 electric cars 1200 kilowatts that travel on a single charge 500 km×20=10,000 ten thousand km.
4—Diesel cost=95 riyals×3=285 riyals compared to the cost of diesel within 10 hours, the cost of the charging device and operating costs=285×100 halals÷1200 kilowatts 20 vehicles=0.24 halals, the cost of the kilowatt.
5—Fast charging of a car of 60 kilowatts/hour×0.24=14.40 riyals.
6—The charge of the invention is less=39−14.40=24.60 riyals, at a rate of 120% VAT.

The invention aims to expand the charging infrastructure instead of the limited charging connected to the public electricity networks.

The invention can be easily applied, especially in government complexes, commercial complexes, airports, universities, and open or closed public parking lots, because it does not need to be connected to the public electricity networks.

The invention is environmentally friendly as a result of using the catalytic converter to purify exhaust.

The invention is equipped with the Internet of Things and artificial intelligence technologies that allow for instant payment and automatic operation of generators during charging only and then turned off to save energy and exhaust together.

The invention will provide a lot of stations and mobile charging points. It may encourage some owners of electric car factories to reconsider reducing the size+weight of the battery, and it may reduce the cost of the vehicle as a whole and reduce the possibility of batteries igniting during accidents and others.

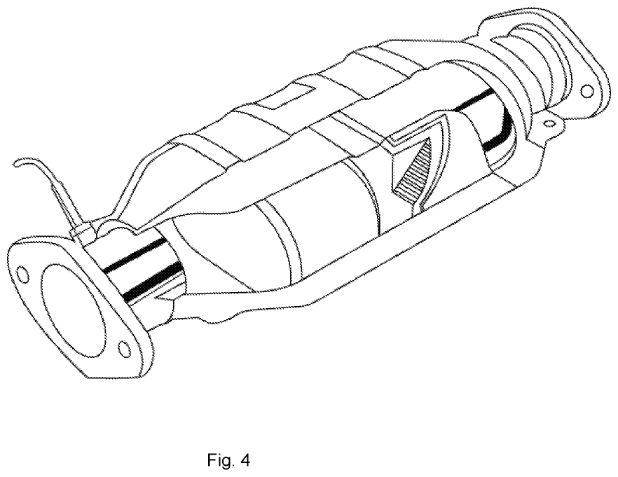

The mobile invention has two sectors, the first within cities and the second on slow and fast land roads. It is equipped with a towing trailer that is directly connected to the rear of the charger car. In the event of customer contact, he can go to him immediately to transport his car on the trailer and operate the generator and the charging device to charge his car while they are on the road and within half an hour or more. Charging is done, and part of the way is cut off to avoid waiting, as in FIG. 3) of the illustrations.

The invention is enough to fill the shortage of charging points in Europe and many countries of the world.

The invention provides a lot of job opportunities to operate mobile charger cars.

The stations of the invention do not operate except in times of need. They stop at night and other hours, which are considered distinguished in saving both fuel and exhaust.

The invention is easily applicable for industrial applications.

Electric cars and the future of the use of solar cells Solar roofs will help enhance the range that the solar roof (which works on charging the battery through solar energy) of the Vision EQXX can add up to 25 km of range per day. The solar system is also unique because the energy from the cells is stored in a separate lithium-iron-phosphate battery that supplies power to the coolant, infotainment system, lights, and other systems. This reduces stress on the high-voltage battery system and enhances range.

Solar cells can be installed on the canopies of electric charging stations and fossil fuel stations together to supply these stations with energy and will have an effective effect in sunny areas, including the Gulf region.

### Various Electrical Sockets:

Some observers see consumers' fear of the difficulties they face in terms of recharging electric cars, as many of them have refrained from buying electric cars for the reason that recharging stations are not available due to their high cost and, at the same time, use different sockets for charging operations, and different levels of electric power in addition to Types of plugs are not standardized.

In light of these complexities, Nissan, BMW, and Tesla have expressed their willingness to cooperate on developing global standardized technologies for charging electric cars on the basis that all consumers should use a simplified and unified way to charge their cars.

On May 23, 2021, BMW: Confirmed that electric cars have great advantages, although it believes that this type of car will not lead the market unless there are enough charging stations, and no one will buy an electric car unless he can charge it near his home or workplace, and the European Union must be aware of this.

The World Intellectual Property Organization (WIPO) does not require new scientific discoveries for patents but rather improvements and developments on existing technology in itself.

For example, development and improvement allow the product to be more efficient or cost-effective, and the organization is managed with bright minds that improve the appreciation of the interests of countries and people.

### Fleet Charging:

Electric vehicle fleet charging solutions require a DC charger to support all vehicle types and charging needs. These DC chargers come with the latest hardware design and application software technology. It also allows seamless integration with payment platforms. These DC chargers can accommodate from 30 kW to 300 kW of power.

### 2^{nd} Level Charging:

A device on a voltage of 40 volts AC is more expensive than a device of the first level and bears a higher voltage; it shortens the battery's charging time, as it is much faster than the first level. It takes an electric charger of this type with a power of 7 kW from 7 to 8 hours to charge a car with a capacity of 60 km Watts per hour.

### 3^{rd} Level Charging:

A device from one of the high-energy electric chargers (HPC) that can carry out rapid charging of level 3 DC at a rate of 50 kilowatts or more, and the electric generator has a capacity of 45 to 60 kilowatts or more.

The previous technician of charging systems for mobile or stationed electric cars, in most of them, depending on charging devices that were pre-packaged by charging them through the public electricity network at the time of low consumption, or they depended on home charging at any time, and most of them are subject to charging the first or second level. Focus on mentioning studies, reports, and comparisons in the background of the invention.

And the previous technician had failed to find a radical solution to the problem of the potential increase in electric cars and the consequent congestion due to the lack of third-level fast charging stations and most importantly of all; the previous technician had failed to find a solution to reduce carbon emissions due to the heavy charging uses associated with public electricity networks.

The invention provides many other advantages and benefits besides the aforementioned, which are economic and social benefits. The invention simply contributes to increasing the quality of life for individuals and societies. Let us imagine the many queues of cars waiting for the purpose of charging, so we can say that the invention achieves sustainability in every way. Their meanings are that the invention is flexible, easy, and fast in meeting the need. For example, but not limited to, the mobile charging system can contain a number of mobile robotic devices with first or second-level charging that go down and move inside the car parks. The service is provided to consumers while they are in their workplace by request Immediate or pre-order.

### GENERAL DESCRIPTION OF THE INVENTION

The current invention fell under the mobile and stationed charging services for electric cars using an integrated system that achieves charging efficiency, flexibility, and ease. Fast charging can be requested at any time and anywhere because it is an integrated system installed on self-driving or driverless vehicles; the invention added catalytic converters to purify the exhaust.

### A BRIEF EXPLANATION OF GRAPHICS

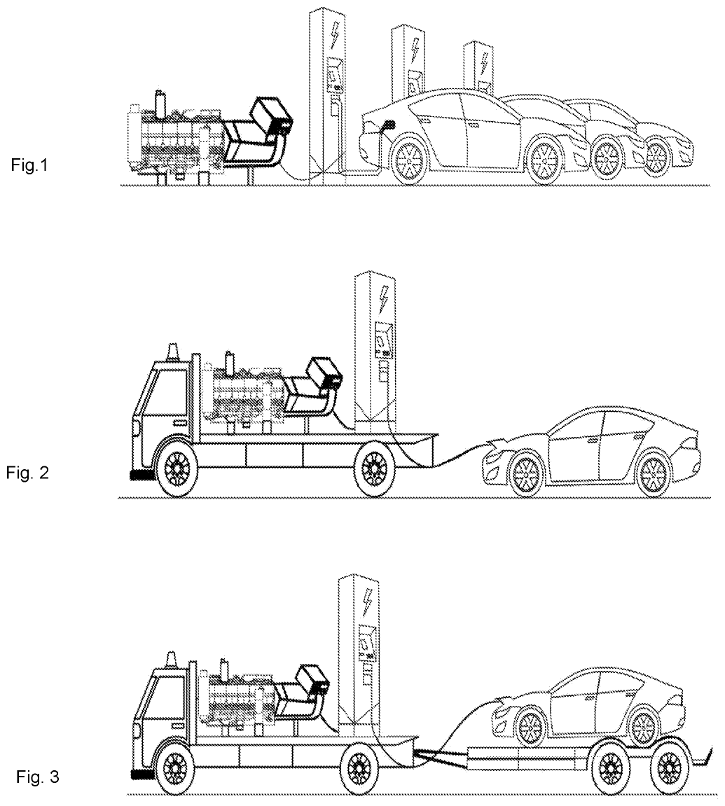

FIG. 1 shows the fixed charging stations and the system's ease of operation.

FIG. 2 shows mobile charging stations on vehicles.

FIG. 3 A figure illustrating the highway road trailer.

FIG. 4 shows the catalytic converter for exhaust purification.

1- An electric vehicle charging system comprising:
one or more stationary electric vehicle charging stations; and
one or more mobile charging stations;
wherein the one or more stationary electric vehicle stations and the one or more mobile charging stations are used to increase availability of charging stations for electric vehicles.

2- The electric vehicle charging system of claim 1, wherein the one or more stationary electric vehicle charging stations and the one or more mobile charging stations are charged using one or more electric generators, the one or more electric generators having a capacity of at least 45 kilowatts.

3- The electric vehicle charging station system of claim 2, wherein the system is configured to protect public electricity networks from a combination of overloads, network stress, and power outages.

4- The electric vehicle charging station system of claim 3, wherein the system comprises one or more high power chargers (HPC) comprising a level 3 charging level, the level 3 charging level providing a fast rate of charge to the electric vehicles.

5- The electric vehicle charging station system of claim 4, wherein the system is configured for capable installation and operation anywhere according to user needs.

6- The electric vehicle charging station system of claim 5, wherein the system is installed and operated on one or more of traditional or electric self-driving cars or user operated cars within cities and villages, and wherein the system comprises cloud control networks allowing reception of requests for charging vehicles.

7- The electric vehicle charging station system of claim 5, wherein the system is able to expand its services.

8- The electric vehicle charging station system of claim 2, wherein the electric generators comprise catalytic converters to purify exhausts.

9- The electric vehicle charging station system of claim 8, wherein the system is configured for application to industrial vehicles.
